(19) United States
(12) Patent Application Publication
(10) Pub. No.: US 2017/0244768 A1
(43) Pub. Date: Aug. 24, 2017

(54) PARTICIPANT-SPECIFIC FUNCTIONS WHILE INTERACTING WITH A SHARED SURFACE

(71) Applicant: Microsoft Technology Licensing, LLC, Redmond, WA (US)

(72) Inventors: Francis Zhou, Redmond, WA (US); Connor Weins, Seattle, WA (US); Albert Hwang, Seattle, WA (US); Narasimhan Raghunath, Redmond, WA (US)

(21) Appl. No.: 15/048,927

(22) Filed: Feb. 19, 2016

(51) Int. Cl. H04L 29/06

(52) U.S. Cl. CPC H04L 65/4015

(57) ABSTRACT

A collaboration system that facilitates a collaboration session with a first participant and a second participant is provided. The collaboration system varies a response to input based on the participant who provides the input. The collaboration system may receive input data from a participant interacting with a shared surface. When the input data is received from the first participant, the collaboration system generates first output data that may be a modification of the first input data that is based at least on first customization information associated with the first participant and displays the first output data. When the input data is received from the second participant, the collaboration system generates second output data that may be a modification of the second input data that is based at least on second customization information associated with the second participant and displays the second output data.

### BACKGROUND

Participants in a collaboration session may use an electronic whiteboard to input and record the electronic writings (e.g., text and drawings) of the session. An electronic whiteboard may be a large touch screen that is connected to a computer. Participants may use a stylus (or finger) to touch the display and input their writings. As the computer receives notifications of contact with the touch-screen display, the computer outputs data to the display to show the participant their input in a process referred to as echoing the input.

Electronic pens have been developed that store an identifier to identify the pen. When a user writes with a pen on a touch-screen display, the pen transmits its identifier to the computer. For example, the pen may transmit its identifier using wireless communications such as Bluetooth technology or Wi-Fi. The computer can then associate the identifier of the pen with the writing.

### SUMMARY

A collaboration system for facilitating a collaboration session with a first participant and a second participant is provided. In some examples, output data that is displayed during the collaboration session varies based on whether input data is received from the first participant or the second participant. The collaboration system receives input data from a participant interacting with the shared surface who is identified by a participant identification. When the participant identification indicates that the input data is received from the first participant, the collaboration system generates first output data that may be a modification of the first input data that is based at least on first customization information associated with the first participant and displays the first output data on the shared surface. When the participant identification indicates that the input data is received from the second participant, the collaboration system generates second output data that may be a modification of the second input data that is based at least on second customization information associated with the second participant and displays the second output data on the shared surface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of a collaboration system in some examples.

FIG. 2 is a flow diagram that illustrates processing of a display customized input data component of the collaboration system in some examples.

FIG. 3 is a flow diagram that illustrates processing of a select output data component of the collaboration system in some examples.

FIG. 4 is a flow diagram that illustrates processing of a display resource content component of the collaboration system in some examples.

FIG. 5 is a flow diagram that illustrates processing of a perform function component of the collaboration system in some examples.

### DETAILED DESCRIPTION

A method and system for facilitating a collaboration session conducted with a shared surface (e.g., touch-screen display) for input and output is provided. In some examples, a system, such as a collaboration system, customizes a response to an interaction with the shared surface based on the identification of the participant who is interacting with the shared surface. For example, if one participant writes an “X” on a signature line, the collaboration system replaces the “X” with that participant's previously stored signature. If another participant, however, writes an “X” on the signature line, then the collaboration system will replace the “X” with that other participant's signature. To support the customization of a response, the collaboration system receives input data from a participant interacting with the shared surface and a participant identification identifying the participant. For example, the participant may provide the input data to a computing device by writing on the shared surface with an electronic pen that transmits its identifier. The collaboration system may maintain a mapping of pen identifiers to participant identifications (e.g., names) of participants in the collaboration session. Upon receiving the pen identifier, the collaboration system determines whether the input data is received from a first participant or a second participant based at least on participant identification of the participant. The collaboration system may access the mapping to identify the participant identification that is mapped to the pen identifier. The pen may also be configured to transmit the participant identification directly. If the input data is received from the first participant, then the collaboration system generates first output data based on a modification of the first input data and displays the first output data.

The modification may be based at least on first customization information associated with the first participant. Similarly, if the input data is received from the second participant, then the collaboration system generates second output data based on a modification of the second input data and displays the second output data. The modification may be based at least on second customization information associated with the second participant. For example, the first customization information may indicate that the first participant has a preference to replace “US” with “United States,” and the second customization information may indicate that the second participant has a preference to replace “US” with “U.S.” When the first participant enters “US,” the collaboration system generates “United States” as the first output data and displays “United States” in place of “US.” When the second participant enters “US,” the collaboration system generates “U.S.” as the second output data and displays “U.S.” in place of “US.” The output data that is displayed during the collaboration session thus varies based on whether the input is received from the first participant or the second participant. In this way, the collaboration system generates output data that is a modification of the input data that is customized to the participant who enters the input data.

In some examples, the collaboration system may base the modification of the input data on various types of customization information relating to a participant. If the customization information relates to handwriting of a participant, then the collaboration system modifies input handwriting based on the handwriting. For example, if the participant frequently replaced the symbol “Z” with “Z,” the collaboration system may automatically perform the replacement for that participant but not for other participants.

If the customization information indicates the participant's preference to have their handwriting “cleaned up,” the collaboration system may echo a cleaned-up version of the input handwriting of that participant by smoothing lines, connecting letters, changing the slant of the letters, and so on.

If the customization information relates to past input text associated with the participant, then the collaboration system may modify input text based on the past text. For example, if the participant often confuses the spelling of certain homonyms when using a keyboard to enter text, the collaboration system may automatically correct the spelling. In such a case, if the participant almost always enters “maid” when meaning “made” and has never actually meant the word “maid,” the collaboration system may always replace the input text of “maid” with “made” for that participant.

If the customization information identifies the language of the participant, then the collaboration system may generate output data that is a correction of the input data based on the language of the participant. For example, the collaboration system may change “dos” to “do's” if the language is English, but not change “dos” if the language is Spanish.

If the customization information identifies the dominant hand of the participant, then the collaboration system may differentiate contact caused by the palm of the dominant hand as the participant pauses when writing from a contact being made by a finger of the non-dominant hand during the pause.

In some examples, the collaboration system may allow a participant to register the pen that each participant will be using during the collaboration session. For example, the collaboration system may display a list of possible participants (e.g., from a company directory) and prompt each participant to select their name in connection with the pen they will be using. As a participant selects their name, the pen identifier is transmitted to the collaboration system. The collaboration system then maps the pen identifier to the selected name. If the pen does not have the capability to transmit an identifier or a finger is being used to write, the participant may use another device such a wrist device, pocket device, and so on that continually transmits a unique identifier over a short distance. In such a case, the collaboration system may use the unique identifier that appears to be coming from the device that is closest to the shared surface (e.g., based on signal strength) as that of the device of the participant who is writing on the shared surface.

In some examples, a system, such as a collaboration system, facilitates interleaved input by multiple participants of data that is displayed on a shared surface and the selecting of a participant's data. The collaboration system receives first input data from a first participant interacting with the shared surface and a first participant identification identifying the first participant. The collaboration system establishes an association between the first input data and the first participant based at least on the first participant identification and displays first output data corresponding to the first input data. For example, the first participant may draw a diagram on the shared surface and the first output data may be a cleaned-up version of the diagram (e.g., lines straightened and arrowheads with a consistent size). The collaboration system may then receive second input data from a second participant interacting with the shared surface and a second identification identifying the second participant. The collaboration system then establishes an association between the second input data and the second participant based at least on the second participant identification and displays second output data corresponding to the second input data. For example, the second participant may add to the diagram drawn by the first participant. The collaboration system may then receive a request to select output data of the second participant. In response, the collaboration system selects the second output data based at least on the association between the second input data and the second participant. The collaboration system then takes an action relating to the selected second output data. For example, the action may be to remove or change a display characteristic (e.g., highlighting, color, or formatting) of the selected second output data.

In some examples, the collaboration system may allow a participant to select their output data by selecting a selection icon with their pen. The collaboration system may use the pen identifier to identify the participant and then select the output data of the identified participant. The collaboration system may highlight the selected output data (e.g., by flashing) to indicate its selection. The participant may then select a trash can icon to remove the selected output data or select a color to change the color of the selected output data. Alternatively, rather than selecting a selection icon, a participant may select a trash can icon with their pen to have their output data selected and removed.

In some examples, a system, such as a collaboration system, varies the response to an interaction with a participant on a participant-by-participant basis. For example, when one participant selects a folder icon, a list of files owned by the participant is displayed. When another participant selects the same folder icon, a list of files owned by that other participant is displayed. The collaboration system receives an indication of an action associated with a resource from a participant interacting with the shared surface and a participant identification identifying the participant. The collaboration system determines whether the indication is received from a first participant or a second participant based at least on the participant identification. When the indication is received from the first participant, the collaboration system displays on the shared surface first output data derived from first content of a first resource associated with the first participant. When the indication is received from the second participant, the collaboration system displays on the shared surface second output data derived from second content of a second resource associated with the second participant. For example, if the resource is a clipboard, the first output data may be content from a first clipboard of the first participant. In addition, the collaboration system may control access by the second participant to the first output data based on access control rights associated with the first resource. For example, the access control rights may indicate that the second participant does not have the right to modify the first resource (e.g., to delete a file of the first participant).

In some examples, a system, such as a collaboration system, facilitates a collaboration session with a first participant and a second participant by performing different functions depending on whether an activation mechanism of a first input device is activated or an activation mechanism of a second input device is activated. The collaboration system receives an indication of an activation of an activation mechanism of an input device and a participant identification identifying a participant. For example, a participant may press a button on the barrel of their pen, and an indication of the pressing is sent to the collaboration system. The collaboration system determines whether the indication is received from a first input device associated with the first participant or a second input device associated with the second participant based at least on the participant identification. When the indication is received from the first input device, the collaboration system performs a first function that is associated with activation of the activation mechanism of the first input device. When the indication is received from the second input device, the activation system performs a second function (different from the first function) that is associated with activation of the activation mechanism of the second input device. For example, the first participant may configure the first function to be an “undo” function that removes the most recent output data of the first participant. The second participant may configure the second function to toggle between bold and un-bold so that when toggled to bold, the subsequent input data of the second participant will result in the display of output data that is bolded.

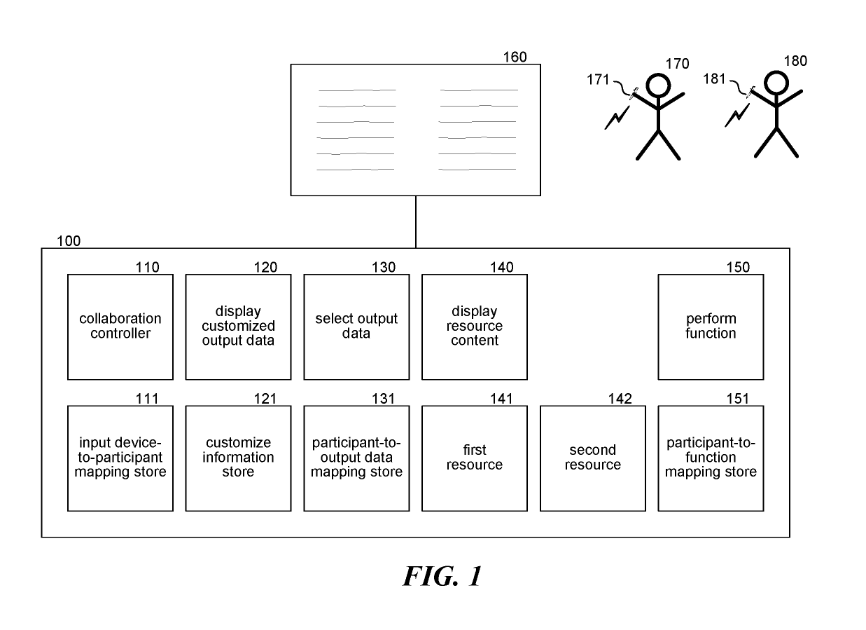

FIG. 1 is a block diagram that illustrates components of a collaboration system in some examples. A collaboration system 100 is implemented on a computing device that interfaces with a touch-screen display 160 and input device 171 associated with participant 170 and input device 181 associated with participant 180. The touch-screen display may be connected to the computer via a wired connection and the input devices may be connected to the computing device via wireless connections.

The collaboration system may include a collaboration controller component 110, a display customized output data component 120, a select output data component 130, a display resource content component 140, and a perform function component 150. The collaboration controller component controls the overall collaboration among the participants and invokes the other components of the collaboration system. The collaboration controller component receives input data based on the interactions of the participants with the touch-screen display using their input devices. The collaboration controller component also receives participant identifications from the input devices of the participants. The collaboration controller component stores the input data in association with the participant identification of a participant who provided the input data. The collaboration controller component generates output data based on the input data and displays the output data on the touch-screen display. The collaboration controller component may interact with an input device-to-participant mapping store 111 that maps the identifiers of input devices to participant identifications. The collaboration controller component may allow each participant to register their input device and stores the mapping in the input device-to-participant mapping store.

The display customized output data component is invoked to generate output data that is customized based on customization information associated with the participant who provided the corresponding input data. The display customized output data component may interact with a customization information store 121 that stores customization information relating to each participant. For example, the customization information store may contain preferences of the various participants. The customization information store may be stored in a distributed manner with each participant's preferences being stored on a storage medium allocated to that participant. For example, each participant may have an account with a data center that provides cloud-based services with the customization information being stored on a storage medium associated with each participant's account. When a participant registers their pen, the participant may also supply credentials (e.g., a password) to the collaboration system so that the collaboration system can access the storage medium allocated to the participant.

The select output data component allows a participant to select the output data associated with a certain participant and apply an action to the selected output data. The collaboration system stores a mapping of participant identifications to their corresponding output data in a participant-to-output data store 131. The display resource content component controls the display of content of resources that are specific to a participant. For example, a first resource 141 may contain content of the first participant, and a second resource 142 may contain content of a second participant. The resources of each participant may be stored in a storage medium allocated to that participant as described above. The perform function component performs different functions based on which participant activates an activation mechanism. A participant-to-function mapping store 151 may store a mapping of participant identifications to the functions. The participant-to-function mapping store of each participant may be stored in a storage medium allocated to that participant as described above.

The computing devices or computing systems on which the collaboration system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, electronic pens, and so on. The computing systems may include servers of a data center, massively parallel systems, and so on. The computing systems may access computer-readable media that include computer-readable storage media and data transmission media. The storage media, including computer-readable storage media, are tangible storage means that do not include a transitory, propagating signal. Examples of computer-readable storage media include memory such as primary memory, cache memory, secondary memory (e.g., DVD), and other storage media. The computer-readable storage media may have recorded on them or may be encoded with computer-executable instructions or logic that implements the collaboration system. The data transmission media are used for transmitting data via transitory, propagating signals or carrier waves (e.g., electromagnetism) via a wired or wireless connection. The data may be transmitted using various data transmission protocols such as the Transmission Control Protocol (TCP), the Internet Protocol (IP), user datagram protocol (UDP), and so on. The computing system may communicate with a data center that provides cloud-based service to the participants. The computing systems may include a secure cryptoprocessor as part of a central processing unit for generating and securely storing keys and for encrypting and decrypting data using the keys.

The collaboration system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. The collaboration system may interface with an operating system, such as WINDOWS, to input and output data using conventional system calls provided by the operating system. Aspects of the collaboration system may be implemented in hardware using, for example, an application-specific integrated circuit (ASIC).

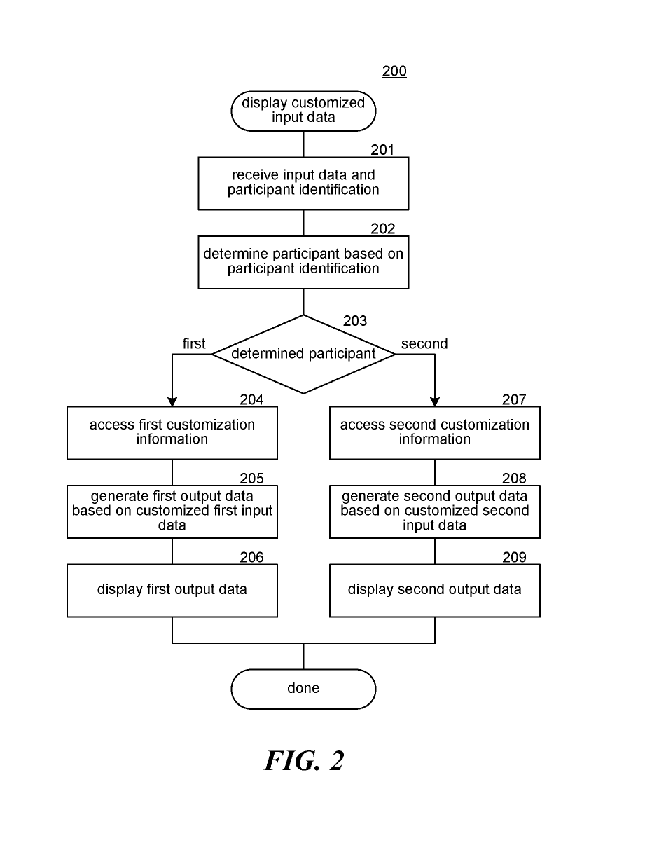

FIG. 2 is a flow diagram that illustrates processing of a display customized input data component of the collaboration system in some examples. A display customized input data component 200 generates customized output data corresponding to input data based on customization information of the participant who inputs the input data. In block 201, the component receives input data and a participant identification. In block 202, the component determines who the participant is based on the participant identification. The component may access the input device-to-participant mapping store to determine the participant. In decision block 203, if the determined participant is a first participant, then the component continues at block 204, else if the determined participant is a second participant, then the component continues at block 207. Although illustrated as having two participants, a collaboration system can have any number of participants in a collaboration session. In block 204, the component accesses first customization information of the first participant. In block 205, the component generates first output data that is a customization of the first input data. For example, the component may clean up the handwriting of the first participant or apply autocorrections specified by the first participant as indicated by the customization information. In block 206, the component displays the first output data and completes. The component may display the first output data as an echo of the input data as the input data is received or may echo the input data as output data and then replace the output data with the customized output data. In blocks 207-209, the component performs processing similar to that of blocks 204-206, except for the second participant rather than the first participant.

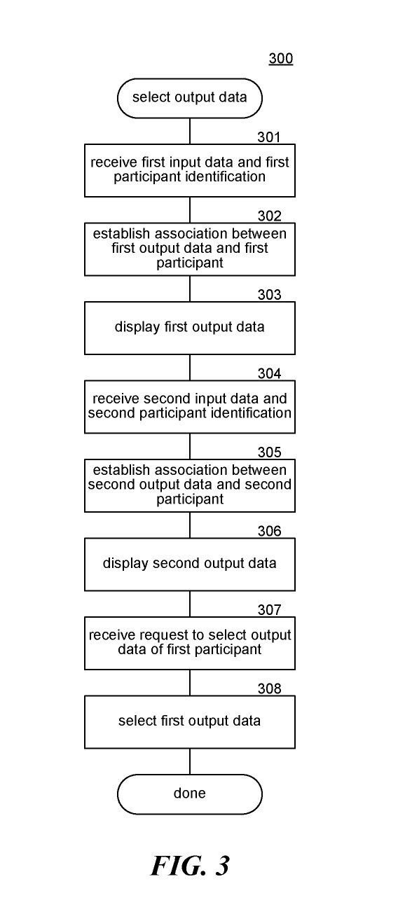

FIG. 3 is a flow diagram that illustrates processing of a select output data component of the collaboration system in some examples. A select output data component 300 selects output data that was input by a certain participant to allow some action to be applied to that output data. In block 301, the component receives first input data and a first participant identification of a first participant. In block 302, the component establishes an association between the first output data corresponding to the first input data and the first participant. In block 303, the component displays the first output data. In block 304, the component receives second input data and a second participant identification of a second participant. In block 305, the component establishes an association between the second output data corresponding to the second input data and the second participant. In block 306, the component displays the second output data. In block 307, the component receives a request to select output data of the first participant. For example, the first participant may select a selection icon with their input device, which transmits the identifier of the input device of the first participant. In block 308, the component selects the first output data based on a mapping of the identifier to the first participant and the correspondence between the first participant and the first output data. The component may also receive a selection of an action and direct that the action be applied to the selected output data. The component then completes.

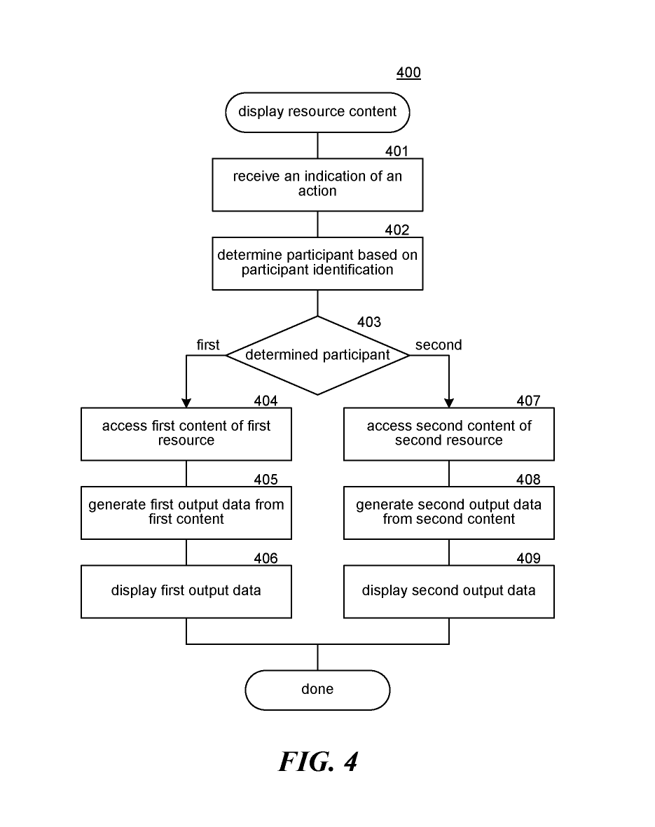

FIG. 4 is a flow diagram that illustrates processing of a display resource content component of the collaboration system in some examples. A display resource content component 400 displays content that is specific to a participant. In block 401, the component receives an indication of an action taken by a participant such as a selection of a folder icon, an email icon, a settings icon, and so forth. The component also receives participant identification. In block 402, the component determines the participant based on the participant identification by accessing the input device-to-participant mapping store. In decision block 403, if the determined participant is the first participant, then the component continues at block 404, else if the determined participant is the second participant, then the component continues at block 407. In block 404, the component accesses first content of a first resource of the first participant. In block 405, the component generates first output data from the first content. For example, if the first resource is a file folder, then the first content may be a list of the files of the first participant that are stored in that file folder. In block 406, the component displays the first output data and then completes. In blocks 407-409, the component performs the same processing as in blocks 404-406, except for the second participant rather than the first participant. The component then completes.

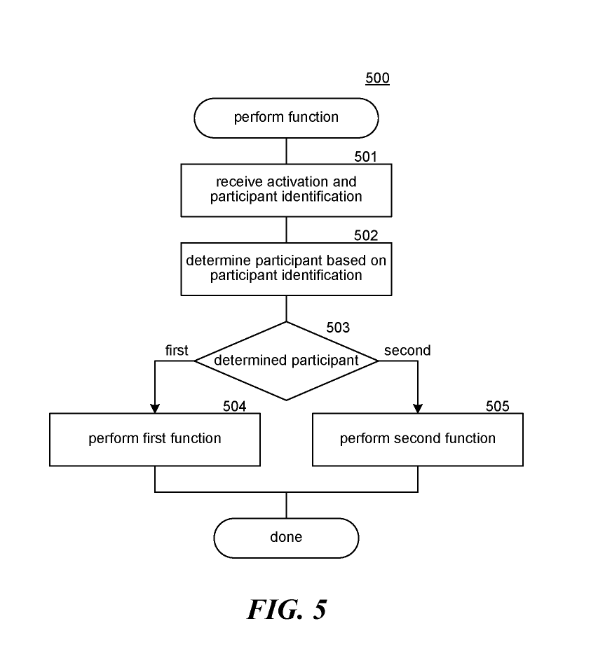

FIG. 5 is a flow diagram that illustrates processing of a perform function component of the collaboration system in some examples. A perform function component 500 is invoked to perform different functions based on which participant activates an activation mechanism. In block 501, the component receives an indication of an activation and a participant identification. In block 502, the component determines the participant based on the input device-to-participant mapping store. In decision block 503, if the determined participant is the first participant, then the component continues at block 504 to perform a first function associated with the first participant and then completes, else if the determined participant is the second participant, the component continues at block 505 to perform a second function associated with the second participant and then completes.

The following paragraphs describe various examples of aspects of the collaboration system. An implementation of a collaboration system may employ any combination of the examples. The processing described below may be performed by a computing device with a processor that executes computer-executable instructions stored on a computer-readable storage medium that implements the collaboration system.

In some examples, a method performed by a computing device for facilitating a collaboration session with a first participant and a second participant is provided. The collaboration session is conducted with a shared surface for output. The method receives input data from a participant interacting with the shared surface. The method accesses a participant identification identifying the participant. Based at least on the participant identification indicating that the input data is received from the first participant, the method generates first output data based at least on a modification of the first input data where the modification is based at least on first customization information associated with the first participant and displays the first output data on the shared surface. Based on at least on the participant identification indicating that the input data is received from the second participant, the method generates second output data based at least on a modification of the second input data. The modification is based at least on second customization information associated with the second participant. The method displays the second output data on the shared surface. In some examples, output data that is displayed during the collaboration session varies based at least on whether the input data is received from the first participant or the second participant. In some examples, the input data is input handwriting of the first participant and the first customization information relates to past handwriting of the first participant. In some examples the method further modifies the input handwriting based on the past handwriting wherein the modified input handwriting is displayed as the first output data. In some examples, the input data is input text received from the first participant and the first customization information relates to past input text associated with the first participant. In some examples, the method further modifies the input text based on the past input text wherein the displaying displays the modified input text as the first output data. In some examples, the input data is received from the first participant and the first customization information identifies a language of the first participant. In some examples, the method further modifies the input text based on the language wherein the modified input text is displayed as the first output data. In some examples, the input data is received from the first participant and the first customization information identifies a dominant hand of the first participant. In some examples, the method further differentiates a contact with the shared surface that inputs the input data from a contact with the shared surface that results from a hand of the first participant contacting the shared surface based at least on the identified dominant hand of the first participant. In some examples, the method determines that the input data is received from the first participant or the second participant based on a signal transmitted to the computing device from a first device associated with the first participant or a second device associated with the second participant. In some examples, the first device is an input device that the first participant uses when interacting with the shared surface to input the first input data.

In some examples, a method performed by a computing device for facilitating manipulation of output data displayed on a shared surface is provided. The output data corresponds to input data input by multiple participants. The method receives first input data from a first participant interacting with the shared surface where the first participant is identified by a first participant identification, establishes an association between first output data and the first participant based at least on the first participant identification, and displays on the shared surface the first output data. The method receives second input data from a second participant interacting with the shared surface where the second participant being identified by a second participant identification, establishes an association between the second output data and the second participant based at least on the second participant identification, and displays on the shared surface the second output data. The method receives a request to select output data of the first participant and selects the first output data based at least on the association between the first output data and the first participant. In some examples, the method applies an action to the selected first output data. In some examples, the action is to remove the first output data from the shared surface. In some examples, the action is to change a display characteristic of the first output data on the shared surface. In some examples, the first participant identification is derived from a first identifier received from a device in the proximity of the first participant. In some examples, the device in the proximity of the first participant is a pen. In some examples, the method recognizes that the first input data is received from the first participant based at least on an association between the first identifier and the first participant identification.

In some examples, a method performed by a computing device for facilitating a collaboration session with a first participant and a second participant is provided. The collaboration session is conducted with a shared surface for input and output. The method receives an indication of an action associated with a resource from a participant interacting with the shared surface where the participant identified by a participant identification. Based at least on the indication being received from the first participant as indicated by the participant identification, the method displays on the shared surface first output data derived from first content of a first resource associated with the first participant. Based at least on the indication being received from the second participant as indicated by the participant identification, the method displays on the shared surface second output data derived from second content of a second resource associated with the second participant. In some examples, the output data that is displayed during the collaboration session varies based at least on whether the indication is received from the first participant or the second participant. In some examples, the resource is a clipboard and the first output data is derived from content of a first clipboard of the first participant. In some examples, the method controls access by the second participant to the first output data based on access control rights associated with the first resource. In some examples, the access control rights indicate that the second participant does not have rights to modify the first resource.

In some examples, a method performed by a computing device for facilitating a collaboration session with a first participant and a second participant is provided. The collaboration session is conducted with a shared surface for input and output. The method receives an indication of an activation by a participant of an activation mechanism of an input device where the participant identified by a participant identification. Based at least on the indication being received from a first input device of the first participant, the method performs a first function that is associated with activation of the activation mechanism of the first input device. Based at least on the indication being received from a second input device of the second participant, the method performs a second function that is associated with activation of the activation mechanism of the second input device. The first function and the second function are different functions. In some examples, the first participant specified that the first function is to be associated with activation of the activation mechanism of the first input device and the second participant specified that the second function is to be associated with activation of the activation mechanism of the second input device.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computing device for facilitating a collaboration session with a first participant and a second participant, the collaboration session being conducted with a shared surface for output, the method comprising:
receiving input data from a participant interacting with the shared surface;
accessing a participant identification identifying the participant;
based at least on the participant identification indicating that the input data is received from the first participant,
generating first output data based at least on a modification of the first input data, the modification based at least on first customization information associated with the first participant; and
displaying the first output data on the shared surface; and
based on at least on the participant identification indicating that the input data is received from the second participant,
generating second output data based at least on a modification of the second input data, the modification based at least on second customization information associated with the second participant; and
displaying the second output data on the shared surface;
wherein output data that is displayed during the collaboration session varies based at least on whether the input data is received from the first participant or the second participant.

2. The method of claim 1, wherein the input data is input handwriting of the first participant and the first customization information relates to past handwriting of the first participant, and further comprising modifying the input handwriting based on the past handwriting wherein the displaying displays the modified input handwriting as the first output data.

3. The method of claim 1, wherein the input data is input text received from the first participant and the first customization information relates to past input text associated with the first participant, and further comprising modifying the input text based on the past input text wherein the displaying displays the modified input text as the first output data.

4. The method of claim 1, wherein the input data is received from the first participant and the first customization information identifies a language of the first participant, and further comprising modifying the input text based on the language wherein the displaying displays the modified input text as the first output data.

5. The method of claim 1, wherein the input data is received from the first participant and the first customization information identifies a dominant hand of the first participant, and further comprising differentiating a contact with the shared surface that inputs the input data from a contact with the shared surface that results from a hand of the first participant contacting the shared surface based at least on the identified dominant hand of the first participant.

6. The method of claim 1, further comprising determining that the input data is received from the first participant or the second participant based on a signal transmitted to the computing device from a first device associated with the first participant or a second device associated with the second participant.

7. The method of claim 6, wherein the first device is an input device that the first participant uses when interacting with the shared surface to input the first input data.

8. A method performed by a computing device for facilitating manipulation of output data displayed on a shared surface, the output data corresponding to input data input by multiple participants, the method comprising:
receiving first input data from a first participant interacting with the shared surface, the first participant being identified by a first participant identification;
establishing an association between first output data and the first participant based at least on the first participant identification;
displaying on the shared surface the first output data;
receiving second input data from a second participant interacting with the shared surface, the second participant being identified by a second participant identification;
establishing an association between the second output data and the second participant based at least on the second participant identification;
displaying on the shared surface the second output data;
receiving a request to select output data of the first participant; and
selecting the first output data based at least on the association between the first output data and the first participant.

9. The method of claim 8, further comprising applying an action to the selected first output data.

10. The method of claim 9, wherein the action is removing the first output data from the shared surface.

11. The method of claim 9, wherein the action is changing a display characteristic of the first output data on the shared surface.

12. The method of claim 8, wherein the first participant identification is derived from a first identifier received from a device in the proximity of the first participant.

13. The method of claim 12, wherein the device in the proximity of the first participant is a pen.

14. The method of claim 12, further comprising recognizing that the first input data is received from the first participant based at least on an association between the first identifier and the first participant identification.

15. A method performed by a computing device for facilitating a collaboration session with a first participant and a second participant, the collaboration session being conducted with a shared surface for input and output, the method comprising:
receiving an indication of an action associated with a resource from a participant interacting with the shared surface, the participant identified by a participant identification;
based at least on the indication being received from the first participant as indicated by the participant identification, displaying on the shared surface first output data derived from first content of a first resource associated with the first participant; and
based at least on the indication being received from the second participant as indicated by the participant identification, displaying on the shared surface second output data derived from second content of a second resource associated with the second participant
wherein output data that is displayed during the collaboration session varies based at least on whether the indication is received from the first participant or the second participant.

16. The method of claim 15, wherein the resource is a clipboard and the first output data is derived from content of a first clipboard of the first participant.

17. The method of claim 15, further comprising controlling access by the second participant to the first output data based on access control rights associated with the first resource.

18. The method of claim 17, wherein the access control rights indicate that the second participant does not have rights to modify the first resource.

19. A method performed by a computing device for facilitating a collaboration session with a first participant and a second participant, the collaboration session being conducted with a shared surface for input and output, the method comprising:
receiving an indication of an activation by a participant of an activation mechanism of an input device, the participant identified by a participant identification;
based at least on the indication being received from a first input device of the first participant, performing a first function that is associated with activation of the activation mechanism of the first input device; and
based at least on the indication being received from a second input device of the second participant, performing a second function that is associated with activation of the activation mechanism of the second input device
wherein the first function and the second function are different functions.

20. The method of claim 19, wherein the first participant specified that the first function is to be associated with activation of the activation mechanism of the first input device and the second participant specified that the second function is to be associated with activation of the activation mechanism of the second input device.
